(19) United States
(12) Patent Application Publication
(10) Pub. No.: US 2008/0105382 A1
(43) Pub. Date: May 8, 2008

(54) Apparatus For Producing A Reinforcement For A Pneumatic Tire

(75) Inventors: Jean-Claude Mayet, Clermont-Ferrand (FR); Emmanuel Blatteyron, Cournon D'Auvergne (FR)

Correspondence Address: COHEN, PONTANI, LIEBERMAN & PAVANE, 551 FIFTH AVENUE, SUITE 1210, NEW YORK, NY, 10176, US

(73) Assignee: MICHELIN RECHERCHE ET TECHNIQUE S.A., Granges-Paccot (CH)

(21) Appl. No.: 11/667,813

(22) PCT Filed: Nov. 9, 2005
(86) PCT No.: PCT/EP05/55862

§ 371 Date: Oct. 17, 2007

(30) Foreign Application Priority Data
Nov. 12, 2004 (FR) 04 12108

(51) Int. Cl. B29D 30/16

(52) U.S. Cl. 156/397

(57) ABSTRACT

An apparatus for producing a pneumatic tire reinforcement, said apparatus being intended to produce a reinforcement consisting of a thread (2) delivered substantially continuously and on demand by an appropriate delivery device, said apparatus being intended to be used in cooperation with a substantially toroidal form (1) on which said reinforcement is progressively built up by depositing arches (3) of said thread along a desired path for said thread on the surface of said form. The apparatus includes: a thread guide (4) in which the thread can slide; means (5) for moving said guide along the desired path for said thread; and first and second pressing means (7, 8) placed respectively on either side of the form and capable of holding the thread against the form substantially at the ends (6) of said arches, wherein the pressing means comprise, at least on a side (B) of the form, a rotary pressing arm (9).

The present invention relates to the manufacture of pneumatic tires. More precisely, it relates to the installation, during building, of threads for constituting a tire reinforcement. More particularly, it provides means and a method that are capable of producing such a reinforcement on a form in a shape close or identical to the shape of the internal cavity of the tire, that is to say on a substantially toroidal form that supports the blank of a tire during its manufacture.

In this technical field, processes and apparatuses for incorporating the production of tire reinforcements into the building of the tire itself are already known. This means that, rather than making use of semi-finished products, such as reinforcement plies, one or more reinforcements are produced in situ at the moment of manufacture of the tire, using a single spool of thread.

Among these processes and apparatuses, the solution described in patent application EP 0 580 055 is particularly well suited for the production of carcass or crown reinforcements on a core, the outer surface of this core corresponding substantially to the shape of the internal cavity of the final tire. The figures of this application show in particular an appliance in which the thread, intended to constitute a carcass reinforcement, is laid in contiguous arches onto a rigid core via an eyelet fixed to a chain mounted on pulleys so as to follow a C-shaped path overlapping the core. The eyelet undergoes a to-and-fro movement about the core so as to lay, progressively and in a contiguous fashion, one arch at each outward movement and one arch at each return. Appropriate pressing means are used to apply the ends of said arches progressively as they are formed on the rigid core, the rigid core being precoated with uncured rubber.

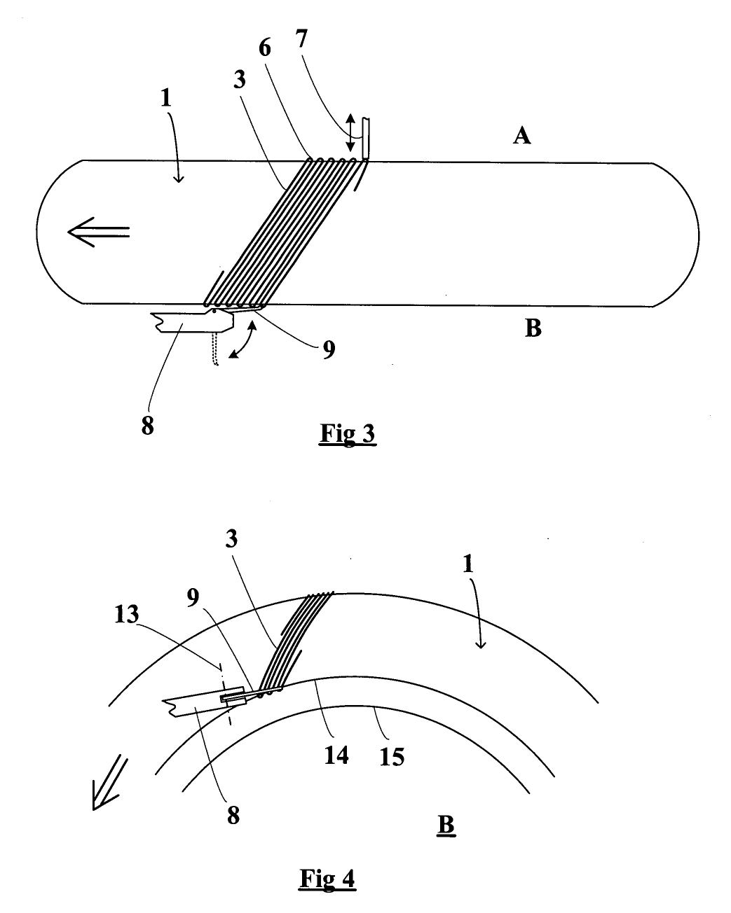

Patent application EP 0 962 304 teaches another apparatus also designed to produce carcass reinforcements on a core, the outer surface of which corresponds substantially to the shape of the internal cavity of the final tire. In a first embodiment, there is a single oscillating arm, the end of which, supporting a guide comparable to the abovementioned eyelet, describes circular arcs. The reader may refer to FIG. 3 of said patent application EP 0 962 304.

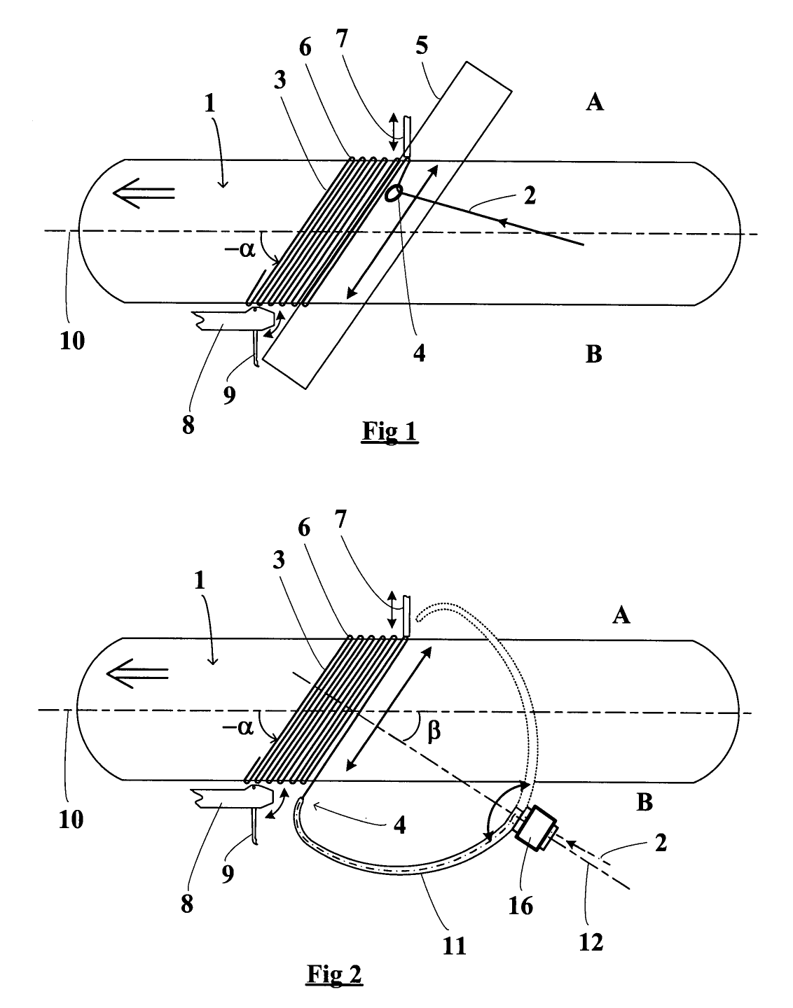

Patent application EP 1 122 057, teaches yet another apparatus for producing reinforcements on a core. In a first embodiment, there is a system of oscillating arms mutually articulated and supporting a guide comparable to the eyelet of document EP 0 580 055. The system is capable of describing a complex path, differing from a circular arc. The reader may refer to FIG. 1 of said patent application EP 1 122 057.

With these apparatuses of the prior art, a difficulty arises when it is desired to lay non-radial reinforcements, for example crossed crown reinforcements. It has been pointed out that, when the laying plane makes an angle to the radial direction, the operation of the pressing means may no longer be entirely satisfactory, in particular at one of the ends of the arches. Under certain conditions, the ends of the arches (generally in the form of loops) may sometimes escape the pressing means. This difficulty could be due to several causes.

One possible cause is the fact that the inclination of the reinforcements implies an unsymmetrical situation from the point of view of the loops created at the ends of the arches on either side of the tire. This is because, on one side of the tire, the loop develops in the same direction as the direction of advance of the form relative to the laying head, whereas on the other side of the tire the formation of the loop corresponds to the instant when the laying takes place in the reverse direction relative to the direction of advance of the form.

Another possible cause of this difficulty is the inclination of the axis of the laying device (relative to the mid-plane of the tire). This inclination may give rise to an asymmetry in the space requirement of said laying device in the vicinity of the form and may thus limit the accessibility of the pressing means at least on one side of the form.

One objective of the present invention is thus to provide apparatuses that are capable of operating according to the general process described in the aforementioned patent application EP 0 580 055 and capable of laying inclined reinforcements at high rates without prejudicing the precision and quality of the operation.

The invention provides an apparatus for producing a pneumatic tire reinforcement, said apparatus being intended to produce a reinforcement consisting of a thread delivered substantially continuously and on demand by an appropriate delivery device, said apparatus being intended to be used in cooperation with a substantially toroidal form on which said reinforcement is progressively built up by depositing arches of said thread along a desired path for said thread on the surface of said form, said apparatus comprising:
a thread guide in which the thread can slide;
means for moving said guide along the desired path for said thread; and
first and second pressing means placed respectively on either side of the form and capable of holding the thread against the form substantially at the ends of said arches,
said apparatus being characterized in that the pressing means comprise, at least on one side of the form, a rotary pressing arm.

Preferably, the path consists of to-and-fro movements substantially parallel to one another and making an angle with the circumferential direction of the form, this angle being less than 90°, preferably less than 45°.

Preferably, the rotary pressing arm can rotate about an axis substantially parallel to the mid-plane of the form and preferably oriented substantially radially.

According to one embodiment of the invention, the means for moving the guide comprise a rocker undergoing an alternating rotational movement about a rocker axis making an angle with the mid-plane of the form, this angle being substantially complementary to the angle that the arches make with the circumferential direction of the form. Preferably, the rocker being mounted so as to pivot on a support, in which the pressing means placed on the side of the form where said support is located comprise the rotary pressing arm.

Preferably, a first rotary striking arm is furthermore associated with the rotary pressing arm, said first rotary striking arm being capable of striking the thread when it is held against the form by the pressing arm. Advantageously, said first rotary striking arm is placed so as to be able to strike the thread against the form at a point on the form located radially to the outside of the point of contact of the rotary pressing arm on the form during the laying of a first reinforcement. Again advantageously, a second rotary striking arm is furthermore associated with the rotary pressing arm, said second rotary striking arm being placed so as to be able to strike the thread at a point located radially to the outside of the point of contact of the rotary pressing arm during laying of a second reinforcement, said second reinforcement being inclined substantially at the reverse of the angle of the first reinforcement.

It should firstly be noted that the term “thread” should of course be understood in a very general sense, encompassing a monofilament, a multifilament, an assembly, for example such as a cable or a cord, or a small number of cables or cords grouped together, irrespective of the nature of the material, and that the “thread” may or may not be precoated with rubber.

In the present specification, the term “arch” is employed to denote a length of thread going from one singular point to another in the reinforcement, for example from one side of the tire blank to the other. These arches placed over the entire perimeter of the tire together form the actual reinforcement. An arch in the sense defined here may form part of a carcass or of a crown reinforcement or of any other type of reinforcement. These arches may be separated, by cutting the thread during laying, or they are all joined together in the final reinforcement, for example by loops.

When a position, direction or sense is defined with the words “radially, axially, circumferentially”, or when the word “radius” is used, these refer to the form of which the tire is manufactured, or to the tire itself. The geometric reference axis is the rotation axis of the form.

Likewise, as already indicated in the aforementioned patent application EP 0 580 055 the thread-laying members described here also make it possible to produce a reinforcement in which the laying pitch of the thread can vary. The term “laying pitch” is understood to mean the distance resulting from the sum of the gap between two adjacent threads and the diameter of the thread. It is well known that, for a carcass reinforcement, the gap between threads varies depending on the radius at which this gap is measured. It is not a question here of this variation, but of a variable pitch at a given radius. To do this, without changing the working rate of the guide, all that is required is to vary the speed of rotation of the form according to any appropriate law. Thus, what is produced is a tire whose carcass reinforcing threads, for example for a radial carcass, are arranged with a pitch varying in a controlled manner for a given radial position.

Fundamentally, the invention relates to the continuous laying-down of a reinforcing thread, in a configuration as close as possible to the configuration visible in the final product, that is to say in the tire. Since the thread is delivered on demand by an appropriate delivery device, for example comprising a spool of thread and where appropriate a device for controlling the tension of the thread paid out from the spool, the apparatus for producing a reinforcement from a single thread cooperates with a form (such as a rigid core or a membrane) on which the tire is built. It matters little whether the reinforcement is, to be complete, produced in several successive rotations of the form, with or without the thread being cut between two rotations.

The rest of the description will allow all the aspects of the invention to be clearly understood, by relying on the following figures:

FIG. 1 is a schematic plan view of a first embodiment of the apparatus according to the invention;

FIG. 2 is a schematic plan view of another embodiment of the apparatus according to the invention;

FIG. 3 is a view similar to FIGS. 1 and 2 in which the thread-laying member has been omitted;

FIG. 4 is a schematic plan view on side B of FIG. 3;

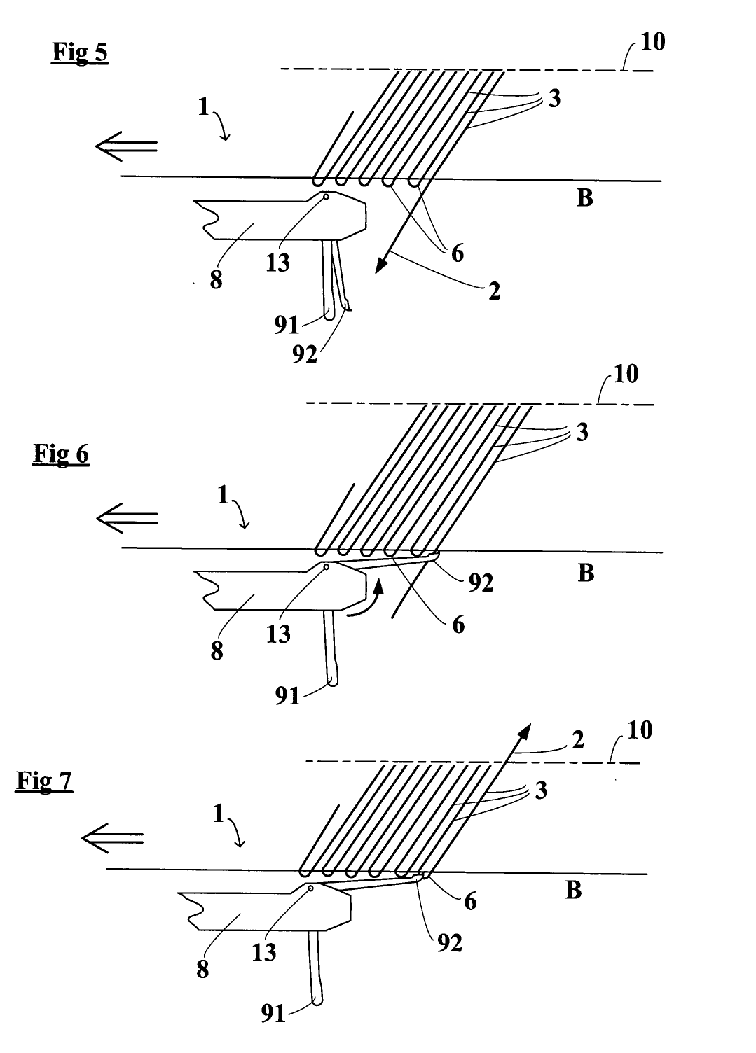

FIGS. 5 to 10 show a preferred sequence in the operation of the rotary pressing means; and

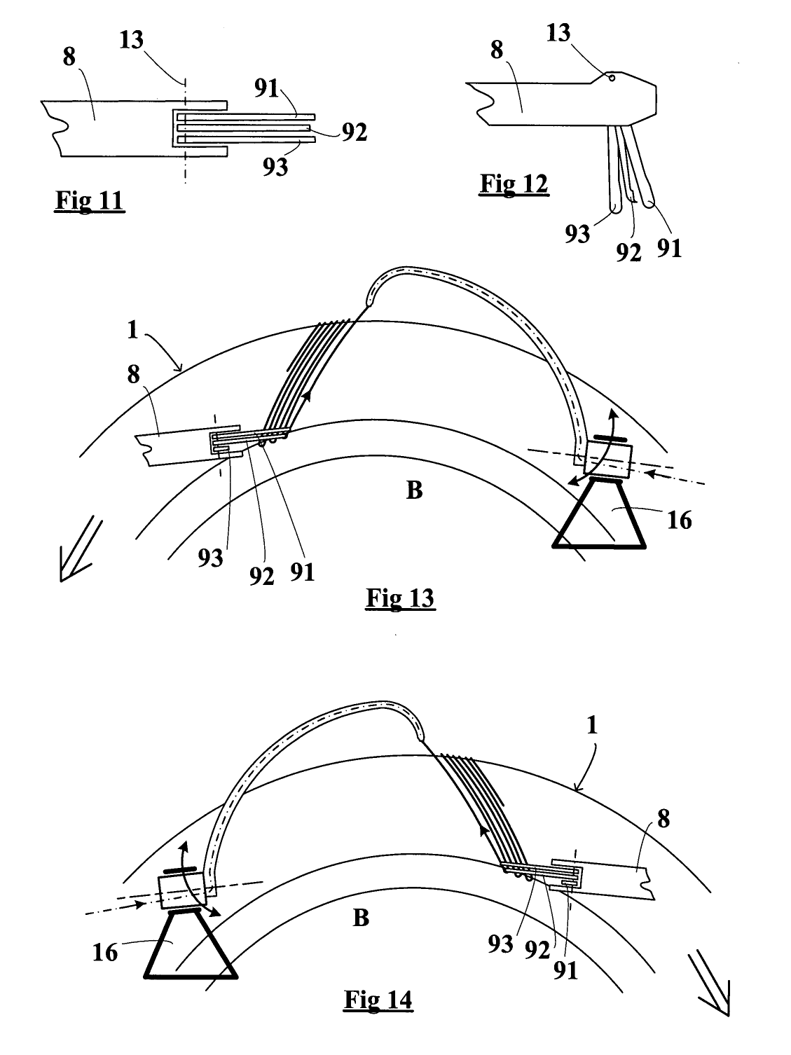

FIGS. 11 to 16 show a preferred embodiment of the rotary pressing means and their method of operation.

In FIG. 1 (and for all the examples illustrated, without however this being limiting), the form 1 is a core (for example a rigid and removable core) that defines the geometry of the internal surface of the tire. This core is rubber-coated, for example with a layer of rubber compound based on butyl rubber, with a layer of rubber compound for coating the carcass threads, with a layer of carcass threads and with a layer of rubber compound for coating the crown reinforcements. The latter rubber compound layer makes it possible for arches 3 of thread 2 to be retained on the core progressively as they are laid down, by a bonding effect. Of course, the core 1 is rotated (in the direction of the double arrow on the left-hand side of the figures) by any suitable device (not shown). A guide 4 (in this example, an eyelet) guides the thread 2.

The thread is delivered substantially continuously and on demand by an appropriate delivery device (not shown). Thread tension-regulating means (not shown here) are used to control the tension of the thread as it is being laid down. For example, a substantially constant tension may be envisioned or, on the contrary, the tension may be controlled so that it varies depending on the position of the guiding eyelet in its alternating movement.

The movement of the eyelet 4 relative to the core is controlled by a laying member 5, for example of the type described in application EP 0 580 055. The thread is thus laid down on the surface of the core in the form of juxtaposed arches 3, the distance between two successive arches corresponding to the laying pitch. The laying pitch is determined by the speed of rotation of the form 1 and the speed of movement of the eyelet 4.

The arches 3 are joined together by loops 6. These loops correspond to the point of return of the thread when the guide 4 reaches one of the axial ends of its movement. The arches make an angle −α with the mid-plane 10 of the core 1 and consequently with the circumferential direction of the future tire. These plan views (in particular FIGS. 1 to 3) show schematically a constant angle −α over the entire length of the arches 3. In practice, this angle may vary, in particular owing to the variations in laying radius, the speed of movement of the eyelet and the speed of rotation of the form 1. As is usual in the art, when the angle of the arches is mentioned without additional information, the angle that the threads make at the center of the arches is considered. Also as usual, this angle is positive when the thread moves away from the mid-plane 10 in the clockwise direction and is negative when the thread moves away from the mid-plane 10 in the counter-clockwise direction (as is the case in FIGS. 1 and 2).

FIG. 2 shows another embodiment of the laying member. Here, this is a rocker 11, the tubular end of which constitutes the guide 4. The rocker 11 oscillates about a rocker axis 12 from one side of the form 1 to the other, as shown schematically in the figure by the representation of one position of the rocker indicated by the solid lines and another position indicated by the broken lines. The rocker axis 12 passes through the support 16. The thread 2 may be conveyed to the guide 4 via a passage inside the rocker 11. The rocker axis 12 makes an angle β with the mid-plane 10 of the form. If the effect (described above) of the rotation speed of the core is disregarded, this angle β is complementary to the angle α (at the center of the arches), i.e. α+β is approximately equal to 90°.

Pressing means are used to press the loops 6 against the form 1. FIGS. 1 to 3 show, on either side of the form, two types of fundamentally different pressing means. On one side (side A of the form, that is to say above the form in FIGS. 1 to 3), the pressing means 7 comprise one or two axially mobile elements. These elements are for example the elements described in application EP 1 122 057 (see in particular the description of the fork and hammer of FIG. 2 of this application). On the other side B of the form, that is to say below the form in FIGS. 1 to 3), the pressing means 8 comprise at least one rotary pressing arm 9. As may be clearly seen in the figures, the approach and bearing movement of the pressing arm 9 is a rotary movement, whereas the movement of the pressing means 7 is a substantially axial translational movement.

FIGS. 3 and 4 show, more specifically, these pressing means and in particular the rotary pressing means 8. In FIG. 3, the rotary arm 9 is shown in the position in which it bears against the form 1. Its folded position can be seen by the dotted lines. In FIG. 4, that is to say in a view from side B, it may be seen that the rotation between these two positions takes place around an axis 13 that is practically radial and parallel to the mid-plane form. In practice, the orientation of the axis 13 may be chosen over a wide range. One element in this choice is of course the inclination of the surface of the form at the point at which the loops 6 are pressed against the form 1. In the example shown, the arches 3 constitute the crown reinforcements of a tire, the profile of which is close to a circular arc, as is the case for a motorcycle tire. If the arches extend, as here, as far as the circle 14 of the axially outermost points of the form, a rotation axis 13 parallel to the mid-plane 10 of the form may be preferred. If it is imagined that the arches 3 constitute a carcass reinforcement (whether radial or not), that is to say that they extend beyond the circle 14 and as far as the bead 15 of the tire, an orientation of the axis 13 that is not parallel to the mid-plane of the form will be preferred.

The series of FIGS. 5 to 10 corresponds to one particularly advantageous method of operating the apparatus of the invention. These detailed views correspond to an enlargement of the part of FIGS. 1 to 3 relating to the rotary pressing means 8. These show one particular embodiment of the rotary pressing means 8, comprising two rotary arms. One of these arms bears, at its end, a hammer 91 and the other arm bears, at its end, a hook 92. These may pivot independently of each other about the same axis. The form 1 is depicted by the return line 14 corresponding to the ends of the arches 3. The arches have only been shown in part.

The sequence of FIGS. 5 to 10 illustrates a preferred method of operating the apparatus.

In FIG. 5, the two pressing arms are released from the form 1. The arch 3 of the thread 2 is laid down by the laying members (not shown) from side A to side B of the form.

In FIG. 6, the hook 92 comes into contact with the form 1, at the return line, overlapping the thread 2.

In FIG. 7, the hook 92 remains applied against the form, keeping the core in position, while the laying members start to form a new arch 3. This has the effect of creating a new loop 6.

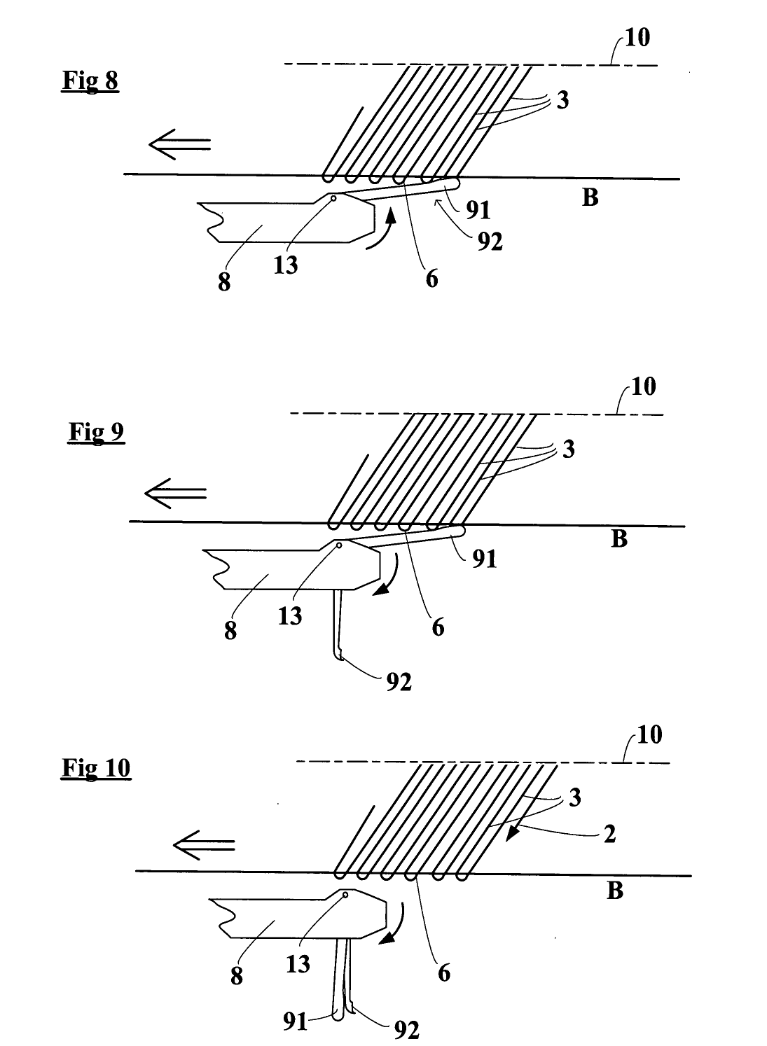

In FIG. 8, while the hook 92 remains applied against the form, the hammer 91 borne by the striking arm in turn presses the thread against the form, preferably by striking it so as to promote its adhesion. Advantageously, the hammer acts on top of the hook, that is to say on that part of the arch lying between the hook and the mid-plane of the form. In other words, the hammer preferably acts as a point on the thread located radially to the outside of the point of contact of the pressing arm bearing the hook 92.

In FIG. 9, the hook 92 is released from the form, while the hammer 91 advantageously remains applied against the form.

In FIG. 10, the striking arm (hammer 91) is in turn released from the form. The situation is now again very similar to that of FIG. 5. The laying member, during this cycle, has performed a forward-and-back movement relative to the form and the laying of a pair of arches has been completed.

It will be clearly understood that the apparatus of the invention may also have only a single rotary pressing arm, as shown in FIGS. 1 to 4. This is because, depending for example on the thread/form adhesion characteristics, on the profile of the form or on the tension of the thread, it may be sufficient to use a single rotary pressing arm. Preferably, the single rotary arm then has a hook-shaped end.

FIGS. 11 and 12 show another embodiment of the rotary pressing means 8. As may be seen, this variant comprises three rotary arms. Two of these arms are striking arms, each bearing a hammer (91, 93) at its end, and the third arm bears a hook 92 at its end. These three arms may pivot independently of one another about the same axis 13. In practice, these pressing means may operate exactly as described in FIGS. 5 to 10, it being observed that, to produce a first reinforcement, only a first hammer (91 in FIG. 11) located above the hook 92 is operational. The second hammer 93 remains disengaged and inactive. The second hammer 93 becomes active only during production of a second reinforcement inclined in the opposite direction through the first. To do this, the pressing means 8 are positioned inversely.

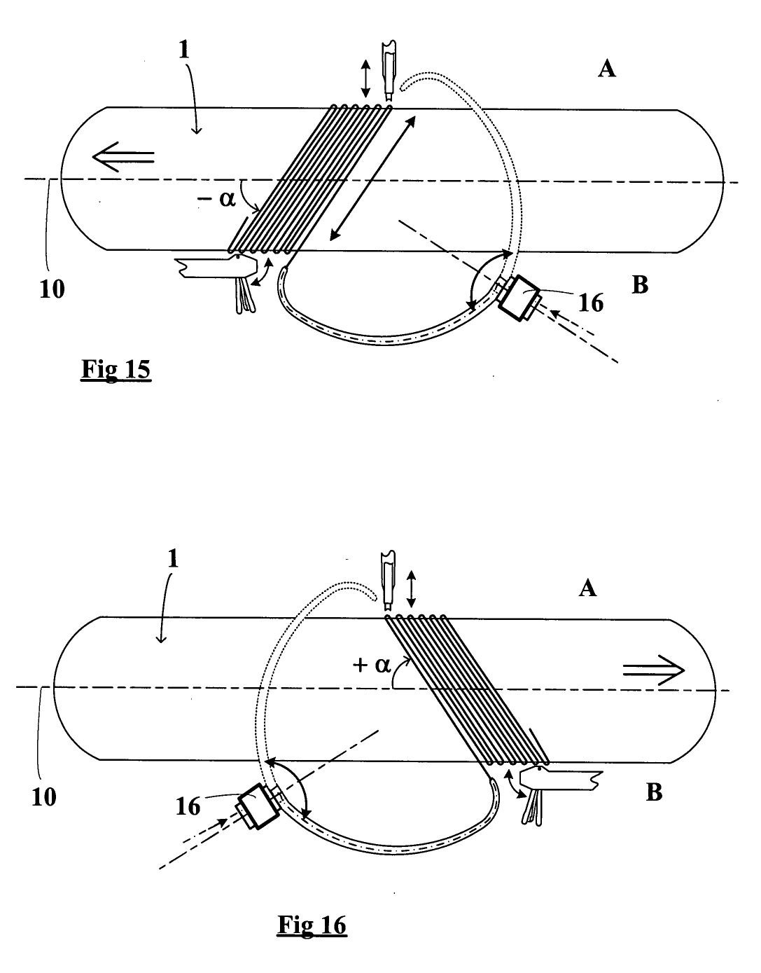

This inversion possibility is shown in FIGS. 13 to 16. FIGS. 13 and 15 show the laying of a first reinforcement inclined at an angle −α, as in FIGS. 1 to 10. To do this, seen from side B, the form 1 rotates to the left of the figure (see the double arrow), the rotary pressing means 8 are located on the left of the figure, and the support for the laying member is located on the right. FIGS. 14 and 16 show the laying of a second reinforcement inclined at an angle +α, that is to say the reverse of FIGS. 1 to 10. To do this, seen from side B, the form rotates towards the right in the figure (see the double arrow), the rotary pressing means 8 are located on the right of the figure, and the support for the laying member on the left. It may be seen that the lower hammer is each time disengaged and inactive, this inactive lower hammer being in one case the hammer 93 (FIG. 13) and in the other case the hammer 91 (FIG. 14). One advantage of this inversion possibility is of course to produce a particularly simple appliance since it is possible to lay, no matter what, radial, inclined or crossed reinforcements using the same laying means and the same pressing means, these means operating from the same side of the form.

Of course, it is also possible to use rotary pressing means on both sides (A and B in the figures) of the form. This allows variations in the inclination of the reinforcements and in the designs of the laying member that are even freer to be achieved. However, it will be understood that this is not an indispensable aspect of the invention, the essential point being that one side is equipped with rotary pressing means.

1. An apparatus for producing a pneumatic tire reinforcement, said apparatus being intended to produce a reinforcement comprising a thread (2) delivered substantially continuously and on demand by an appropriate delivery device, said apparatus being intended to be used in cooperation with a substantially toroidal form (1) on which said reinforcement is progressively built up by depositing arches (3) of said thread along a desired path for said thread on the surface of said form,
said apparatus comprising:
a thread guide (4) in which the thread can slide;
means (5) for moving said guide along the desired path for said thread; and
first and second pressing means (7, 8) placed respectively on either side of the form and capable of holding the thread against the form substantially at the ends (6) of said arches,
wherein the pressing means comprise, at least on one side (B) of the form, a rotary pressing arm (9).

2. The apparatus as claimed in claim 1, in which the path consists of to-and-fro movements substantially parallel to one another and making an angle (α, −α) with the circumferential direction (10) of the form, this angle being less than 90°.

3. The apparatus as claimed in claim 2, in which this angle is less than 45°.

4. The apparatus as claimed in claim 1, in which said rotary pressing arm (9) can rotate about an axis (13) substantially parallel to the mid-plane (10) of the form.

5. The apparatus as claimed in claim 1, in which said rotary pressing arm can rotate about an axis (13) oriented substantially radially.

6. The apparatus as claimed in claim 2, in which the means for moving the guide (4) comprises a rocker (11) undergoing an alternating rotational movement about a rocker axis (12) making an angle β with the mid-plane of the form, β being substantially complementary to the angle (α, −α) that the arches (3) make with the circumferential direction of the form.

7. The apparatus as claimed in claim 6, the rocker being mounted so as to pivot on a support (12), in which the pressing means (8) placed on the side (B) of the form where said support is located comprise the rotary pressing arm.

8. The apparatus as claimed in claim 1, in which a first rotary striking arm (91) is furthermore associated with the rotary pressing arm (92), said first rotary striking arm being capable of striking the thread when it is held against the form by the pressing arm.

9. The apparatus as claimed in claim 8, in which said first rotary striking arm is placed so as to be able to strike the thread against the form at a point on the form located radially to the outside of the point of contact of the rotary pressing arm on the form during the laying of a first reinforcement.

10. The apparatus as claimed in claim 9, in which a second rotary striking arm (93) is furthermore associated with the rotary pressing arm, said second rotary striking arm being placed so as to be able to strike the thread at a point located radially to the outside of the point of contact of the rotary pressing arm during laying of a second reinforcement, said second reinforcement being inclined substantially at the reverse of the angle of the first reinforcement.
